(19) United States
(12) Patent Application Publication
(10) Pub. No.: US 2025/0166634 A1
(43) Pub. Date: May 22, 2025

(54) METHOD, APPARATUS, DEVICE, AND STORAGE MEDIUM FOR INFORMATION INTERACTION

(71) Applicant: Beijing Zitiao Network Technology Co., Ltd., Beijing (CN)

(72) Inventors: Shanshan DU, Beijing (CN); Xin ZHONG, Beijing (CN)

(21) Appl. No.: 18/952,710

(22) Filed: Nov. 19, 2024

(30) Foreign Application Priority Data
Nov. 21, 2023 (CN) 202311560774.5

(51) Int. Cl. G10L 17/24; G06F 3/16

(52) U.S. Cl. CPC G10L 17/24; G06F 3/167

(57) ABSTRACT

According to embodiments of the disclosure, a method, an apparatus, a device, and a storage medium for information interaction are provided. The method for information interaction includes: in response to detecting a triggering operation for a scenario recommendation page from a first user, presenting at least one scenario in the scenario recommendation page; and adding a first scenario in the at least one scenario to a scenario list associated with the first user for subsequent selection based on a triggering operation for the first scenario from the first user, or selecting the first scenario for interaction between the first user and a first digital assistant. The at least one scenario is configured to perform a task related to a corresponding scenario in the interaction between the first user and a first digital assistant.

### CROSS-REFERENCE

The present application claims priority to Chinese Patent Application No. 202311560774.5, filed on Nov. 21, 2023 and entitled “METHOD, APPARATUS, DEVICE, AND STORAGE MEDIUM FOR INFORMATION INTERACTION”, the entirety of which is incorporated herein by reference.

### FIELD

Example embodiments of the present disclosure generally relate to the field of computers, and more particularly, to a method, apparatus, device, and computer-readable storage medium for information interaction.

### BACKGROUND

With rapid development of Internet technologies, the Internet has become an important platform for people to obtain content and share the content. A user may access the Internet through a terminal device to enjoy various Internet services. The terminal device presents corresponding content through a user interface of an application and implements interaction with the user and provides a service for the user. Therefore, interaction interfaces of various applications are important for improving user experience. With the development of information technology, various terminal devices can provide various services for people in work, life, and other aspects. For example, an application providing a service may be deployed in a terminal device, and the terminal device or the application may provide a digital assistant type function for a user, to assist the user in using the terminal device or the application. How to improve the flexibility of interaction between a user and a digital assistant is a technical problem to be explored at present.

### SUMMARY

In a first aspect of the present disclosure, a method of information interaction is provided. The method includes: in response to detecting a triggering operation for a scenario recommendation page from a first user, presenting at least one scenario in the scenario recommendation page; and adding a first scenario in the at least one scenario to a scenario list associated with the first user for subsequent selection based on a triggering operation for the first scenario from the first user, or selecting the first scenario for interaction between the first user and a first digital assistant, wherein the at least one scenario is configured to perform a task related to a corresponding scenario in the interaction between the first user and a first digital assistant.

In a second aspect of the present disclosure, a method of information interaction is provided. The method includes: in response to an operation for publishing a first scenario, obtaining first publishing information of the first scenario, wherein the first scenario is configured with corresponding configuration information to execute a task of a corresponding type, the configuration information comprises at least one of scenario setting information or plug-in information, wherein the scenario setting information is configured for describing information related to a corresponding scenario, and the plug-in information indicates at least one plug-in for performing a task in a corresponding scenario; and publishing the first scenario to a target digital assistant based on the first publishing information, so that the target digital assistant performs a relevant task based on the first scenario.

In a third aspect of the present disclosure, an apparatus for information interaction is provided. The apparatus includes: a detecting module configured to present, in response to detecting a triggering operation for a scenario recommendation page from a first user, at least one scenario in the scenario recommendation page; and an adding module configured to add a first scenario in the at least one scenario to a scenario list associated with the first user for subsequent selection based on a triggering operation for the first scenario from the first user, or select the first scenario for interaction between the first user and a first digital assistant, wherein the at least one scenario is configured to perform a task related to a corresponding scenario in the interaction between the first user and a first digital assistant.

In a fourth aspect of the present disclosure, an apparatus for information interaction is provided. The apparatus includes: a publishing information obtaining module configured to obtain, in response to an operation for publishing a first scenario, first publishing information of the first scenario, wherein the first scenario is configured with corresponding configuration information to execute a task of a corresponding type, the configuration information comprises at least one of scenario setting information or plug-in information, wherein the scenario setting information is configured for describing information related to a corresponding scenario, and the plug-in information indicates at least one plug-in for performing a task in a corresponding scenario; and a scenario publishing module configured to publish, based on the first publishing information, the first scenario to a target digital assistant, so that the target digital assistant performs a relevant task based on the first scenario.

In a fifth aspect of the present disclosure, there is provided an electronic device, the device including at least one processing unit; and at least one memory, the at least one memory being coupled to the at least one processing unit and storing instructions for execution by the at least one processing unit. The instructions, when executed by the at least one processing unit, cause the apparatus to perform the method of the first aspect and/or the second aspect.

In a sixth aspect of the present disclosure, a computer readable storage medium is provided, where the computer readable storage medium stores a computer program thereon, and the computer program is executable by a processor to implement the method in the first aspect and/or the second aspect.

It should be understood that what is described in this section is not intended to limit the critical features or essential features of the embodiments of the present disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment in which embodiments of the present disclosure can be implemented;

FIGS. 2A-2D illustrate schematic diagrams of example client interfaces of an interaction window according to some embodiments of the disclosure, respectively;

FIGS. 3A-3C illustrate schematic diagrams of example client interfaces for creating a scenario according to some embodiments of the disclosure, respectively;

FIG. 4A illustrates a flowchart of a process for information interaction according to some embodiments of the disclosure;

FIG. 4B illustrates a flowchart of a process for information interaction according to some other embodiments of the present disclosure;

FIG. 5A illustrates a block diagram of an apparatus for information interaction according to some embodiments of the disclosure;

FIG. 5B illustrates a block diagram of an apparatus for information interaction according to further embodiments of the present disclosure; and

FIG. 6 illustrates a block diagram of an electronic device in which one or more embodiments of the present disclosure may be implemented;

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes but are not intended to limit the scope of the present disclosure.

In the description of the embodiments of the present disclosure, the term “including” and the like should be understood as open-ended including, that is, “including but not limited to”. The term “based on” should be read as “based at least in part on”. The term “one embodiment” or “the embodiment” should be read as “at least one embodiment”. The term “some embodiments” should be understood as “at least some embodiments”. Other explicit and implicit definitions may also be included below.

Herein, unless explicitly stated, “performing a step in response to A” does not mean that the step is performed immediately after “A”, but one or more intermediate steps may be included.

It will be appreciated that the data involved in the technique solution (including but not limited to the data itself, the obtain, use, storage or deletion of the data) should comply with the requirements of the corresponding legal regulations and related provisions.

It should be understood that, before the technical solutions disclosed in the embodiments of the present disclosure are used, the related users should be of the type, application scope, and application scenario of the personal information involved in this disclosure in an appropriate manner and the related user's authorization shall be obtained, in accordance with relevant laws and regulations, wherein the related users may include any type of entitlement bodies, such as individuals, enterprises, and groups.

For example, in response to receiving an active request from a user, prompt information is sent to the relevant user to explicitly prompt the relevant user that the operation requested to be performed will require acquiring and using personal information of the related user, so that the related user may autonomously select, according to prompt information, whether to provide information for software or hardware such as an electronic device, an application, a server, or a storage medium that executes the operation of the technical solutions of the present disclosure.

As an optional but non-limiting implementation, in response to receiving an active request of a related user, prompt information is sent to the user, for example, in the form of a pop-up window, and the pop-up window may present the prompt information in the form of text. In addition, the pop-up window may also carry a selection control for the user to select whether he/she “agrees” or “disagrees” to provide information to the electronic device.

It should be understood that, the above notification and user authorization process are only illustrative which do not limit the implementation of this disclosure. Other methods that meet relevant laws and regulations can also be applied to the implementation of this disclosure.

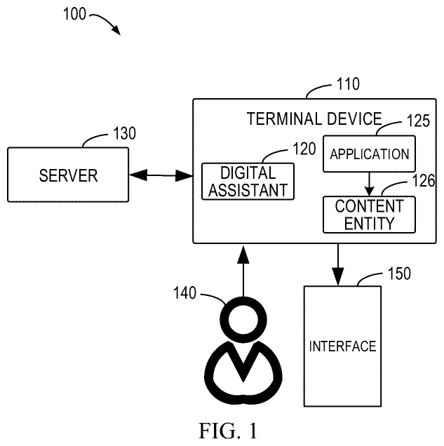

FIG. 1 shows a schematic diagram of an example environment 100 in which embodiments of the present disclosure can be implemented. In this example environment 100, a digital assistant 120 and an application 125 are installed in a terminal device 110. The user 140 may interact with the digital assistant 120 and the application 125 via the terminal device 110 and/or an attached device of the terminal device 110.

In some embodiments, the digital assistant 120 and the application 125 may be downloaded, installed at the terminal device 110. In some embodiments, the digital assistant 120 and the application 125 may also be accessed in other ways, such as through a web page, etc. In the environment 100 of FIG. 1, in response to an application 125 being started, the terminal device 110 may present a digital assistant 120 and an interface 150 of the application 125.

The applications 125 include, but are not limited to, one or more of a chat application (also known as an instant messaging application), a document application, an audio-video conferencing application, an email application, a task application, a calendar application, a objectives and key result (OKR) application, and so forth. Although a single application is shown in FIG. 1, a plurality of applications may be installed on the terminal device 110 in practice. In some embodiments, the application 125 may include a multifunctional collaboration platform, for example, an office collaboration platform (also referred to as an office suite) can provide integration of a plurality of types of applications or components, so as to facilitate people's activities such as office work and communication. In a multifunctional cooperative platform, people can start different applications or components as required to complete corresponding information processing, sharing, communication, etc.

The application 125 may provide a content entity 126. The content entity 126 may be a content instance created on the application 125 by a user 140 or another user. By way of example, depending on the type of application 125, the content entity 126 may be a document (e.g., a word document, a pdf document, a presentation, a form document, and the like), an email, a message (e.g., a conversation message on an instant messaging application), a calendar, a calendar, a task, an audio, a video, an image, and the like.

In some embodiments, the digital assistant 120 may be provided by a separate application, or may be integrated in a certain application 120 capable of providing a content entity. An application for providing a client interface for a digital assistant may correspond to a single-function application or a multi-function collaboration platform, such as an office suite or other collaboration platform capable of integrating multiple components. In some embodiments, the digital assistant 120 supports the use of plugins. Each plugin can provide one or more functions of an application. Such plug-ins include, but are not limited to, one or more of a search plug-in, a contacts plug-in, a message plug-in, a document plug-in, a table plug-in, a email plug-in, a calendar plug-in, a calendar plug-in, a task plug-in, and the like.

The digital assistant 120 is a user's intelligent assistant, which has an intelligent conversation and information processing capability. In the embodiments of the present disclosure, the digital assistant 120 is configured for interacting with a user 140, to assist the user 140 in using a terminal device or an application. An interaction window with the digital assistant 120 may be presented in the client interface. In the interaction window, the user 140 may have a conversation with the digital assistant 120 by inputting a natural language, so as to instruct the digital assistant to assist in completing various tasks, including operations on the content entity 126.

In some embodiments, the digital assistant 120 may be included in a contact list of the current user 140 in an office suite, as a contact of the user 140, or in an information flow of a chat component. In some embodiments, the user 140 has a correspondence with the digital assistant 120. For example, a first digital assistant corresponds to a first user, a second digital assistant corresponds to a second user, and so on. In some embodiments, a first digital assistant may uniquely correspond to a first user, a second digital assistant may uniquely correspond to a second user, and so on. That is, the first digital assistant of the first user may be specific or exclusive to the first user. For example, in a process in which the first digital assistant provides assistance or services to the first user, the first digital assistant may utilize its historical interaction information with the first user, data authorized by the first user that it can access, its current interaction context with the first user, etc. If the first user is an individual or a person, the first digital assistant may be regarded as a personal digital assistant. It can be understood that, in the embodiment of the present disclosure, the first digital assistant accesses data to which it is granted authorization of the first user. It should be understood that “uniquely corresponding to” or similar expressions in this disclosure are not intended to limit that a first digital assistant is to be updated accordingly based on an interaction process between a first user and the first digital assistant. Of course, depending on the needs of the actual application, the digital assistant 120 also need not be specific to the current user 140, but may be a general-purpose digital assistant.

In some embodiments, a plurality of interaction modes of the user 140 with the digital assistant 120 may be provided, and flexible switching between the plurality of interaction modes may be possible. In the event that a certain interaction mode is triggered, a corresponding interaction region is presented to facilitate interaction between the user 140 and the digital assistant 120. In different interaction modes, the user 140 and the digital assistant 120 interact in different manners, so that the interaction requirements in different application scenarios can be flexibly adapted.

In some embodiments, an information processing service specific to user 140 can be provided based on historical interaction information of the user 140 with the digital assistant 120 and/or data range specific to the user 140. In some embodiments, historical interaction information that the user 140 has interacted with the digital assistant 120 in a plurality of interaction modes, respectively, may all be stored in association with the user 140. As such, in one of the plurality of interaction modes (any one or a designated one), the digital assistant 120 may provide services to the user 140 based on historical interaction information stored in association with the user 140.

The digital assistant 120 may be called or evoked in an appropriate manner (e.g., shortcut, button, or voice) to present an interaction window with the user 140. The interaction window with the digital assistant 120 may be opened by selecting the digital assistant 1201. The interaction window may include interface elements for information interaction, such as an input box, a message list, a message bubble, and the like. In other embodiments, the digital assistant 120 may be evoked through n portal control or a menu provided in a page, or may be evoked by inputting a preset instruction.

The interaction window between the digital assistant 120 and the user 140 may include a conversation window, such as a conversation window in an instant messaging module in an instant messaging application or target application. In some embodiments, the interaction window of the digital assistant 120 with the user 140 may include a floating window corresponding to the digital assistant.

In some embodiments, the digital assistant 120 may support a conversation window interaction mode, also referred to as a conversation mode. In the interaction mode, a conversation window between the user 140 and the digital assistant 120 is presented, and in the conversation window, the user 140 interacts with the digital assistant 120 through a conversation message. In the conversation mode, the digital assistant 120 may perform a task according to a conversation message in the conversation window.

In some embodiments, the conversation mode of the user 140 with the digital assistant 120 may be called or evoked in an appropriate manner (e.g., shortcut, button, or voice) to present a conversation window. A conversation window with the digital assistant 120 may be opened by selecting the digital assistant 120. The conversation window may include interface elements for information interaction, such as an input box, a message list, a message bubble, and so on.

In some embodiments, the digital assistant 120 may support an interaction mode of a floating window (or floating window), also referred to as a floating window mode. In a case in which the floating window mode is triggered, an operation panel (also referred to as a floating window) corresponding to the digital assistant 120 is presented, and the user 140 may send an instruction to the digital assistant 120 based on the operation panel. In some embodiments, the operation panel may include at least one candidate shortcut instruction. Alternatively, or additionally, the operation panel may include an input control for receiving instructions. In the floating window mode, the digital assistant 120 may perform a task according to an instruction sent by the user 140 through the operation panel.

In some embodiments, the floating window mode of user 140 and digital assistant 120 may also be called or evoked in an appropriate manner (e.g., shortcut, button, or voice) to present a corresponding operation panel. In some embodiments, evoking of the digital assistant 120 may be supported in a particular application, such as in a document application, to provide floating window mode of interaction. In some embodiments, to trigger the floating window mode to present the operation panel corresponding to the digital assistant 120, a portal control for the digital assistant 120 may be presented in the application interface. In response to detecting the triggering for the portal control, it may be determined that the floating window mode is triggered, and the operation panel corresponding to the digital assistant 120 is presented in the target interface area.

In some embodiments described below, for ease of discussion, an example that an interaction window between a user and a digital assistant is a conversation window is mainly used for description.

In some embodiments, the terminal device 110 communicates with the server 130 to enable provision of the services to the digital assistant 120 and the application 125. The terminal device 110 may be any type of mobile terminal, fixed terminal, or portable terminal including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a game device, or any combination of the foregoing, including accessories and peripherals for these devices, or any combination thereof. In some embodiments, the terminal device 110 can also support any type of interface to a user (such as ‘wearable’ circuitry, etc.). The applications 130 may be various types of computing systems/servers capable of providing computing capabilities including, but not limited to, mainframes, edge computing nodes, computing devices in a cloud environment, etc.

It should be understood that the structure and function of the various elements in environment 100 are described for exemplary purposes only, and are not intended to imply any limitation on the scope of the disclosure.

As mentioned briefly above, the digital assistant can assist a user in using a terminal device or application. Some applications can provide integrated functionality of different plugins. In addition to being capable of conducting a free dialogue with the digital assistant, the user may also enable the digital assistant to use different plug-ins through a natural language instruction to complete some more complex operations related to the application's business, such as creating a document, inviting a schedule, creating a task, and so on. However, since most users cannot explore the usage scenario of the digital assistant by interacting with the digital assistant, it is necessary to provide a targeted guidance for the user. In addition, conventionally, when a digital assistant is needed to perform tasks in different scenarios, a user often needs to interact with different digital assistants (namely, each digital assistant is only used for executing a task under one scenario), which causes information not being stored in one place, and the plurality of digital assistants cannot share information. This makes the interaction function of the digital assistant not flexible enough.

According to some embodiments of the present disclosure, an improved solution for information interaction is provided. In embodiments of the present disclosure, in response to detecting a trigger operation on a scenario recommendation page from a first user, at least one scenario is presented in the scenario recommendation page; and based on a triggering operation for the first scenario in the at least one scenario from the first user, the first scenario is added to scenario list associated with the first user for subsequent selection, or the first scenario for interaction between the first user and a first digital assistant is selected, where the at least one scenario is configured to perform a task related to a corresponding scenario in the interaction between the first user and a first digital assistant. Therefore, in this manner, the user can conveniently select a required scenario through the scenario recommendation page to interact with the digital assistant.

According to some other embodiments of the present disclosure, when a scenario is published, in response to an operation of publishing a first scenario, first publication information of the first scenario is obtained. and based on the first publishing information, the first scenario is published to the target digital assistant, so that the target digital assistant executes a relevant task based on the first scenario. According to this solution, when creating a scenario for a specific digital assistant, a user may publish the created scenario to a specific digital assistant for use. In this way, the interaction capability of the target digital assistant can be continuously enriched.

Some example embodiments of the present disclosure will be described in detail below with reference to examples of the accompanying drawings.

As described above, in the embodiments of the present disclosure, a digital assistant is configured for interaction with a user, and an interaction window for the user to interact with the digital assistant may be presented in a client interface. The interaction window between the user with the digital assistant may include a conversation window in which the interaction between the user and the digital assistant may be presented in the form of a conversation message. Alternatively, or additionally, the interaction window between the user and the digital assistant may also include other types of windows, for example, a window in a floating window mode, in which the user may trigger the digital assistant to perform a corresponding operation by means of inputting an instruction, selecting a shortcut instruction, and the like. As an intelligent assistant, a digital assistant has an intelligent dialog and information processing capability. In an interaction window, a user inputs an interaction message, and the digital assistant provides a reply message in response to the user input. A client interface for providing a digital assistant may correspond to a single-function application or a multi-function collaboration platform, such as an office suite or other collaboration platform capable of integrating multiple components.

In some embodiments, the terminal device 110 may present a conversation window of the user with one or more other users. The conversation window of the user with another user may be, for example, a single-chat window between the user A and the user B, and the conversation window of the user with other users may be, for example, a group chat window between the user A and a group of other users. The user may interact with at least one other user by sending and/or receiving messages in the conversation window. The terminal device 110, for example, may determine message content to be sent by a user in response to detecting text input by the user in an input box. The terminal device 110 may also, for example, collect user audio in response to detecting the user's trigger operation on the audio space. The terminal device 110 may determine the audio or text content corresponding to the audio as the message content to be sent by the user. It should be noted that, the foregoing operations performed by the terminal device 110 and the operations performed by the terminal device 110 subsequently may be specifically performed by a related application installed on the terminal device 110.

In the conversation window, the user may input a message through an input box or by other suitable means (e.g., voice), and the digital assistant may provide a reply message based on the input message and in combination with relevant knowledge. Messages in the conversation window are typically conversation messages, such conversation messages may be considered part of a topic.

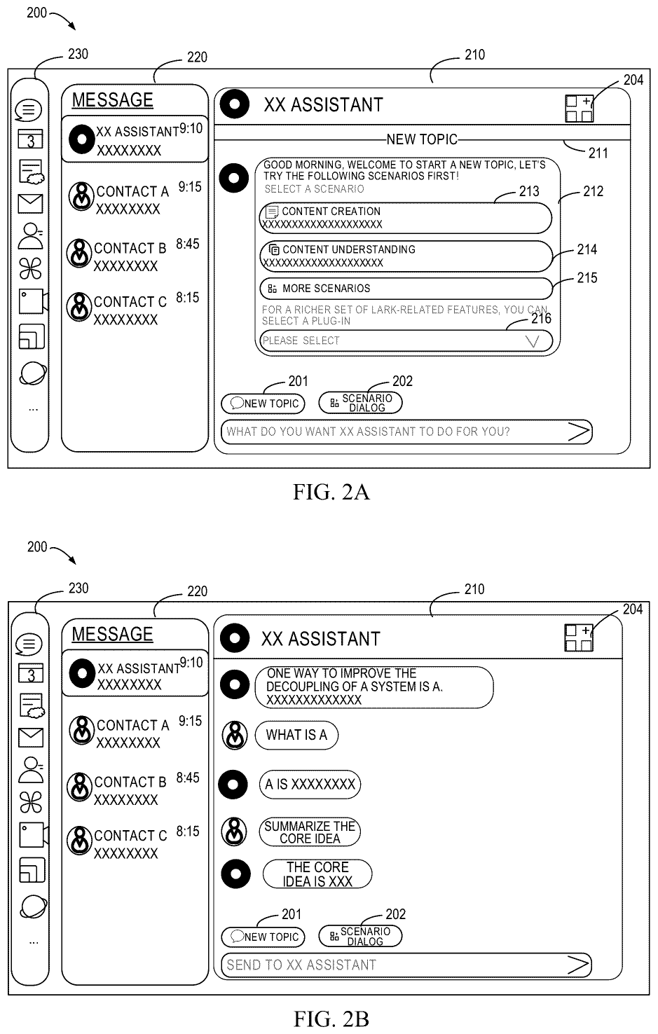

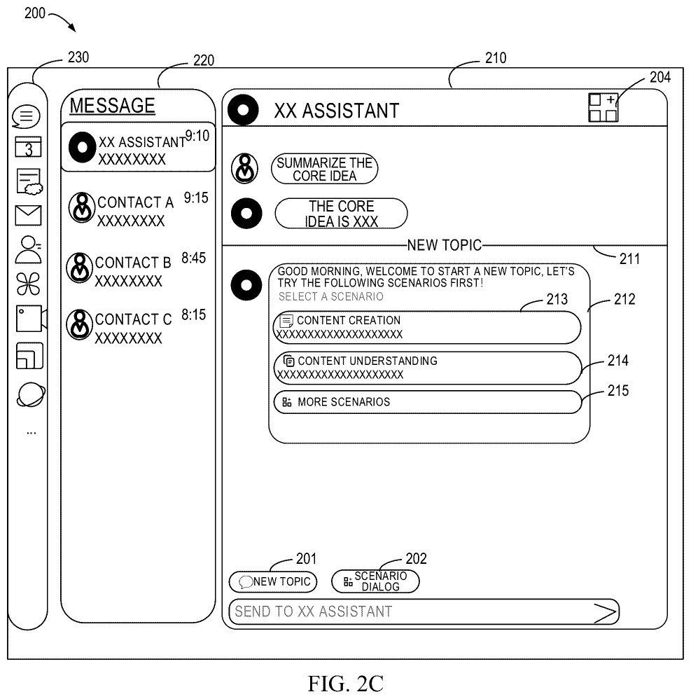

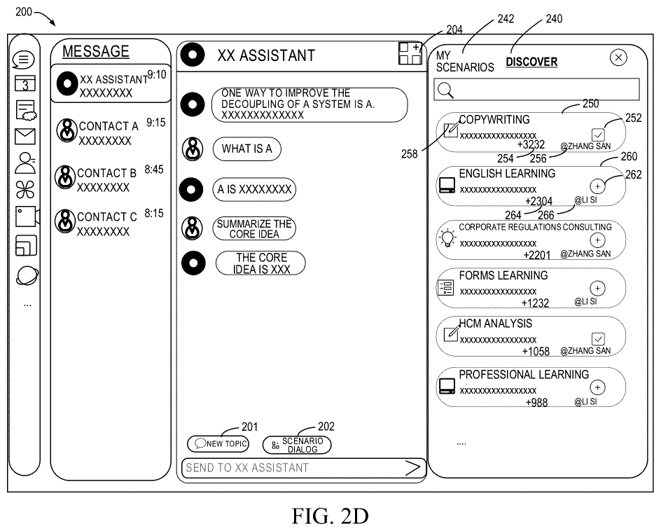

FIGS. 2A-2D illustrate schematic views of an example client interface 200 of an interaction window, according to some embodiments of the present disclosure. The client interface 200 may be implemented at the terminal device 110. Examples of FIGS. 2A-2C are described below with reference to FIG. 1.

In a conversation window between a user and at least one other user, the terminal device 110 (for example, an instant messaging application installed on the terminal device 110, or a suite application installed on the terminal device 110 and integrating with the instant messaging application) may present a trigger control for a digital assistant (for example, a first digital assistant) in response to detecting a preset input in an input box of the conversation window. As shown in FIG. 2A, the start portal of the instant messaging application is presented in an area 230 of the interface 200, and an information feed of the instant messaging application is presented in an area 220 of the interface 200. In response to the user selecting any contact or any group in the information flow of the instant messaging application, the terminal device 110 may present a corresponding conversation window in the area 210 of the interface 200. For example, in response to the user evoking the digital assistant through a preset operation (e.g., selecting the digital assistant from a contact list), the terminal device 110 may present a conversation window (also referred to as a main conversation window) in the area 210 of the interface 200 in which the user interacts with the digital assistant.

In some embodiments, in response to the digital assistant being evoked, the terminal device 110 may open a new topic (e.g., a first topic) in the conversation window by default, and present a segmentation line corresponding to the first topic in the conversation window. As shown in FIG. 2A, in response to the digital assistant being invoked, the terminal device 110 may present the split line 211 corresponding to the new topic and the message card 212 associated with the new topic in the interface 200 by default.

Herein, a “topic” corresponds to a specific context of interaction. During the interaction of each topic, interaction information of a user with a digital assistant is considered as context information, so as to assist the digital assistant in determining a subsequent conversation message. In some embodiments, topics are also sometimes referred to or presented as subjects.

In some embodiments, if there is previous historical interaction information or historical topics between the user and the digital assistant, in, in response to the digital assistant being evoked, the terminal device 110 may present a portion of the historical interaction information or the historical topics in the conversation window. As shown in FIG. 2B, the terminal device 110 may present a portion of previous historical interaction information between the user and the digital assistant in a main conversation window of the interface 200. Alternatively or additionally, in some embodiments, in response to the digital assistant being evoked, the terminal device 110 may also not present a message card 212 and the historical interaction information in the main conversation window.

In some embodiments, the terminal device 110 may start a new topic (e.g., the first topic) in a reply window of the user with the digital assistant in response to receiving an operation to start the new topic. The conversation window may include an input box through which the terminal device 110 may receive a user input, for example. If the terminal device 110 detects that the user input is a user input that indicates start of a new topic, it is determined that an operation to start the new topic is received. In some embodiments, an operation control (e.g., operation control 201 in FIG. 2B) for starting a new topic may also be included in the conversation window. The terminal device 110, for example, may determine that an operation to start a new topic is received in response to detecting the triggering on the operation control 201. The terminal device 110 may then present the main conversation window as shown in FIG. 2A or FIG. 2C.

As shown in FIGS. 2A and 2C, in response to the operation to start the new topic, the terminal device 110 starts the first topic in the main conversation window, presents a segmentation line 211 for the new topic and the previous topic in the interface 200, and presents at least one scenario selectable for use in a conversation area of the first topic. The conversation area for the first topic herein may be, for example, a message card 212. In some embodiments, the terminal device 110 may also present a segmentation line 211 (as shown in FIG. 2C) between the previous topic and the new topic, for example, in response to starting the new topic. The terminal device 110 may present at least one scenario (e.g., a scenario 213 and a scenario 214) in the message card 212.

Herein, in interaction context between a user and a digital assistant, “scenario” refers to a set of tasks of the same type, that is, a scenario corresponds to a plurality of tasks of the same type. One or more scenarios may be respectively configured with corresponding configuration information to perform corresponding types of tasks. For ease of understanding, a scenario applied to the interaction between a user and a digital assistant is briefly introduced first.

The configuration information of the scenario includes at least one of the following: scenario setting information and plug-in information. The scenario setting information is configured to describe information related to a corresponding scenario. The plug-in information indicates at least one plug-in for executing a task in a corresponding scenario. As will be discussed below, the configuration information of the scenario, for example, may further include an indication for the selected model (herein, the model is configured to determine a reply to the user in the corresponding scenario), scenario guidance information (the scenario guidance information being presented to a user after a corresponding scenario is selected), at least one recommendation question for a digital assistant (at least one recommendation question being presented to a user for selection after a corresponding scenario is selected), etc. In some embodiments, the scenario setting information and the configuration information of the scenario may be configured, for example, in a natural language, so that the scenario creator can conveniently restrict an output of a model and configure diversified scenarios.

The configuration information of the scenario includes at least one of the following: scenario setting information and plug-in information. The scenario setting information is configured to describe information related to a corresponding scenario. The scenario setting information of the scenario may affect the reply of the digital assistant to the user to some extent, or may be used to determine the reply of the digital assistant to the user. In some embodiments, the scenario setting information is configured to construct a prompt input to provide to the model used in the corresponding scenario. The reply of the digital assistant to the user is based on the output of the model. The scenario setting information of the scenario may include, for example, a description of a task of a corresponding type, a reply style of the digital assistant in a corresponding scenario, a definition of a workflow to be executed in the corresponding scenario, a definition of a reply format of the digital assistant in the corresponding scenario, and the like. In some embodiments, the digital assistant will understand the user input with the aid of the model and provide a reply to the user based on the output of the model. The model used by the digital assistant may run locally at the terminal device 110 or at a remote server. By constructing a part of a prompt input of the model by using the scenario setting information, the model can be guided to complete a task to be implemented in a corresponding scenario. In some embodiments, the model may be a machine learning model, a deep learning model, a learning model, a neural network, etc. In some embodiments, the model may be based on a language model (LM). The language model can be provided with question-answer capabilities by learning from a large corpus. The model may also be based on other suitable models.

The plug-in information indicates at least one plug-in for executing a task in the corresponding scenario. The plug-in to be used in the corresponding scenario can be configured through the plug-in information of the scenario. In some embodiments, in a corresponding scenario, during running of a plug-in, the plug-in may also call a model to complete a corresponding task. In some embodiments, a plug-in may also invoke an open interface provided by another application (for example, an application such as a document, a calendar, and a conference) to complete a corresponding task, for example, modifying a document, creating a schedule, summarizing a conference, and the like.

In some embodiments, the configuration information of the scenario may further include a name of the scenario, description information of the scenario, and the like. In some embodiments, the terminal device 110 may provide a message card to a user in a conversation window, and at least a part of a group of scenarios may be presented in the message card. The terminal device 110 may present the scenario name of the corresponding scenario and/or the description information of the scenario in the message card, in association with the scenario. For example, the user may select a scenario meeting his/her own requirements based on the scenario name of the scenario and/or description information of the scenario presented in the message card.

In some embodiments, the configuration information of the scenario may also include, but is not limited to, a selected model (herein, the model is evoked to determine a reply to the user in a corresponding scenario), scenario guidance information (scenario guidance information being presented to a user after a corresponding scenario is selected), at least one recommendation question for the digital assistant (at least one recommendation question being presented to a user for selection after a corresponding scenario is selected), any combination of one or more of the foregoing, and the like. The scenario guide information may be, for example, description information of task instances that can be executed in the scenario. In some embodiments, the scenario setting information and the configuration information of the scenario may be configured, for example, in a natural language, so that the scenario creator can conveniently restrict the output of the model and configure diversified scenarios.

In some embodiments, the configuration information of the scenario may also indicate at least one operation control associated with the scenario. As will be described in detail below, at least one operation control associated with the scenario may be presented to the user when the scenario is selected for interaction, to facilitate the user in performing interactions with the digital assistant in the corresponding scenario. That is to say, in a scenario creation process, at least one operation control associated with a corresponding scenario may be configured by a scenario creator. In some embodiments, the scenario setting information and configuration information of the scenario, for example, may be configured by the scenario creator in natural language. In this way, the scenario creator can conveniently restrict the output of the model and configure diversified scenarios.

In some embodiments, if a scenario is selected for interaction between the first user and the first digital assistant, interaction between the first user and the digital assistant is performed in the conversation window based at least on configuration information for the selected scenario. The scenario settings information, the plug-in information, the selected model, etc. for the selected scenario are used to guide interaction in the scenario.

In some embodiments, the terminal device 110 may also present a scenario view control 215 in the message card 212, for example, and the terminal device 110 may trigger presentation of more scenarios in response to detecting a triggering operation for the scenario view control 215. For example, to ensure the simplicity of the main conversation window, where multiple scenarios are included, the terminal device 110 may present only a portion of the scenarios in the operation card 212, and present more scenarios in response to detecting a triggering operation for the scenario view control 215.

In addition to providing views of more scenarios in a message card of a conversation window, in some embodiments, the terminal device may also present a scenario dialogue portal 202 in the conversation window or a scenario dialogue control 204 in a functional bar associated with the conversation window. More scenarios may be triggered to be presented via the scenario dialogue portal 202 or the scenario dialogue control 204.

In an embodiment of the present disclosure, the terminal device 110 presents a scenario recommendation page corresponding to the first user in response to detecting a triggering operation for the first user on the scenario recommendation page. As shown in FIG. 2D, in response to detecting that the user clicks on the scenario dialogue portal 202 in the conversation window presented by the terminal device 110 in the area 210 of the interface 200, or that the user clicks on the scenario conversation control 244 in the conversation window (or detecting a triggering operation for the scenario view control 215), the terminal device 110 presents the scenario recommendation page 240. In some embodiments, the scenario list page associated with the first user (e.g., page 242 corresponding to the “My Scenario” tab illustrated in FIG. 2D) may be presented by default through triggering the scenario dialog portal 202, the scenario dialog control 244, or the scenario view control 215. The user may switch to the scenario recommendation page 240 by clicking on the “Discovery” tab. Other access portals to the scenario recommendation page may be provided in addition to the access portals shown in FIG. 2A to FIG. 2D. Embodiments of the present disclosure are not limited in this regard, although the scenario recommendation page is shown in FIG. 2D as being presented in parallel with the conversation window, in other embodiments, the scenario recommendation page may also be presented separately from the conversation window, may be presented as overlaying the conversation window, or in any other suitable manner, depending on the particular application configuration.

The terminal device 110 presents at least one scenario in the scenario recommendation page 240 for the user to select for interaction or to add to his/her own scenario list. For example, the terminal device 110 presents a scenario name in the scenario recommendation page 240: a copywriting creation scenario 250, an English learning scenario 260, a company regulation consulting scenario, a table learning scenario, an HCM analysis scenario, a professional learning scenario, etc. In some embodiments, the terminal device 110 may present a scenario icon for each of at least one scenario in the scenario recommendation page 240, such as the icon 258 for the Chinese copywriting creation 250 of FIG. 2D. The terminal device 110 may present a scenario description of each of one or more scenarios in the scenario recommendation page 240.

In some examples, the terminal device 110 may further present respective access portals of at least one scenario in the scenario recommendation page 240. By triggering an access portal of a scenario, a corresponding scenario may be selected for interaction between the first user and the first digital assistant. As shown in FIG. 2D, a card corresponding to the copywriting creation scenario 250 is configured as an access portal of the scenario. The first user clicks the copywriting creation scenario 250 to enter the copywriting creation scenario, so that the copywriting creation scenario is used for interaction between the first user and the digital assistant in the conversation window. For example, in a conversation window of first user with a first digital assistant, a new topic can be started based on a copywriting creation scenario. In the newly started topic, the conversation of the first user with the first digital assistant is performed based on the configuration information of the copywriting creation scenario.

In some embodiments, the terminal device 110 may further present respective add controls of at least one scenario in the scenario recommendation page 240. As shown in FIG. 2D, the first user clicks the add control for the copywriting creation scenario 250, so that the copywriting creation scenario 250 can be added to a scenario list (“My Scenario”) associated with the first user. The terminal device 110 presents an adding success control 252 in the copywriting creation scenario 250. Note that it is assumed in FIG. 2D that the copywriting creation scenario 250 has been added to the scenario list associated with the first user, so the add control corresponding to the scenario is transformed to an adding success control. Similarly, the first user may also click on the add control 262 of English learning 260 to add the English learning scenario 262 to the scenario list (“My Scenario”) associated with the first user.

In some embodiments, the terminal device 110 may further present a creation source of each of at least one scenario in the scenario recommendation page 240, where the creation source is used to indicate a creator of the scenario. For example, the creation source may be a team, a user, or the like. As shown in FIG. 2D, the terminal device 110 presents the creation source 256 in the scenario recommendation scenario 250. For example, when Zhang San creates the copywriting creation scenario 250, the terminal device 110 will present a creation source 256 in the form of “@Zhang San” at the copywriting creation scenario 250. For another example, when Li Si creates the English learning scenario 260, the terminal device 110 presents a creating source 256 in a form of “@Li Si” in the English learning scenario 260, and so on.

The terminal device 110 may further present respective addition amount of at least one scenario in the scenario recommendation page 240, where the respective addition amount of the scenario is used to indicate how many users add the scenario, that is, adding the scenario to a respective scenario list. As shown in FIG. 2D, the addition amount of the copywriting creation scenario 250 is 3232, and the terminal device 110 is presented in the form of “+3232” 254 in the copywriting creation scenario 250. The addition amount of the English learning scenario 260 is 3232, and the terminal device 110 is presented in a form 256 of “+3232” in the English learning scenario 260.

The terminal device 110 can add a first scenario in the at least one scenario to a scenario list associated with the first user according to the trigger operation performed by the first user on the first scenario. In some embodiments, in response to detecting the triggering operation by the first user on the adding control of the first scenario, the terminal device 110 adds the first scenario to a scenario (“my scenario”) list associated with the first user, for example, the terminal device 110 may add the first scenario to the “my scenario” list in a floating display manner. The at least one scenario presented by the terminal device 110 is respectively configured to execute a task related to a corresponding scenario in the interaction between the first user and the digital assistant. Exemplarily, when detecting a trigger operation on an access portal of the first scenario, the terminal device 110 selects the first scenario for the interaction between the first user and the first digital assistant. For example, when the first user clicks an adding operation 262 corresponding to the copywriting creation scenario 250, the terminal device 110 adds the first scenario to the “My Scenario” list 242 based on the click operation by the first user, and presents the first scenario in the form of a “tick” 252 on the scenario recommendation page 240.

In some embodiments, the terminal device 110 adds the first scenario to a scenario list associated with the first user, which can facilitate subsequent selection by the first user. The terminal device 110 adds the first scenario to a scenario list associated with the first user, so that the first user can conveniently select the first scenario for interaction with the first digital assistant. The scenarios added to the scenario list associated with the first user may be recommended to the user during subsequent interaction between the first user and the first digital assistant, presented in the scenario boot card, or selected by the first user to interact with the first digital assistant whenever necessary.

In some embodiments, information of a public permission type is used to describe under what conditions at least one scenario may be used by the user. The terminal device 110 determines whether a public permission type of each of at least one scenario is a designated type, where public permission of the designated type may be used to instruct the terminal device 110 to allow a corresponding scenario to be provided in the scenario recommendation page 240, and the public permission of the designated type may also be used to instruct the terminal device 110 to allow a corresponding scenario to be shared through a link. The terminal device 110 presents, according to at least one scenario in which the determined disclosure authority type is the designated type, the scenario recommendation page 240.

The terminal device 110 may determine whether a usable range for each of the at least one scenario includes at least the first user. When the terminal device 110 determines whether the usage range for each of the at least one scenario includes the first user, the terminal device 110 presents the at least one scenario on the scenario recommendation page 240. At least one of a public permission type and a usable range of the scenario may be included in the configuration information of the scenario. In other words, upon creation of a scenario, a public permission type and a usable range of the scenario may be indicated in the configuration information.

In some embodiments, the public permission types may include a first type indicating that the corresponding scenario is allowed to be provided in the context recommendation page 240 of the user within the usable range, a second type indicating that the corresponding scenario is shared through a link by a user within the available range. In some embodiments, the public permission of a scenario may include both a first type and a second type, or may include only one of the types. In some embodiments, if the public permission type of a scenario is the specified type, i.e., the first type indicating that the corresponding scenario is allowed to be provided in the context recommendation page 240 of the user within the usable range, the scenario may be presented in the scenario recommendation page of the user within the usable range.

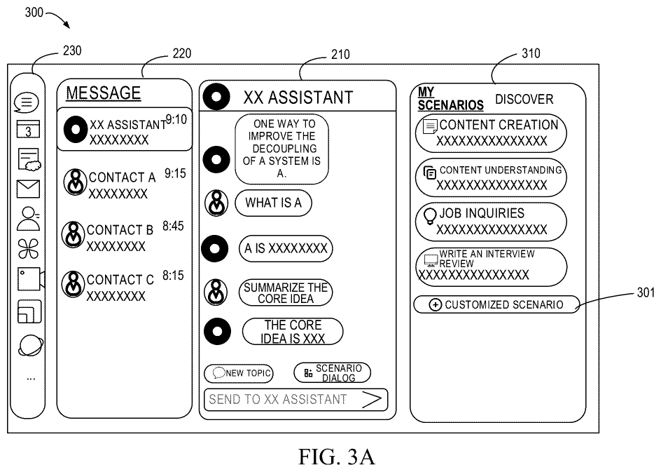

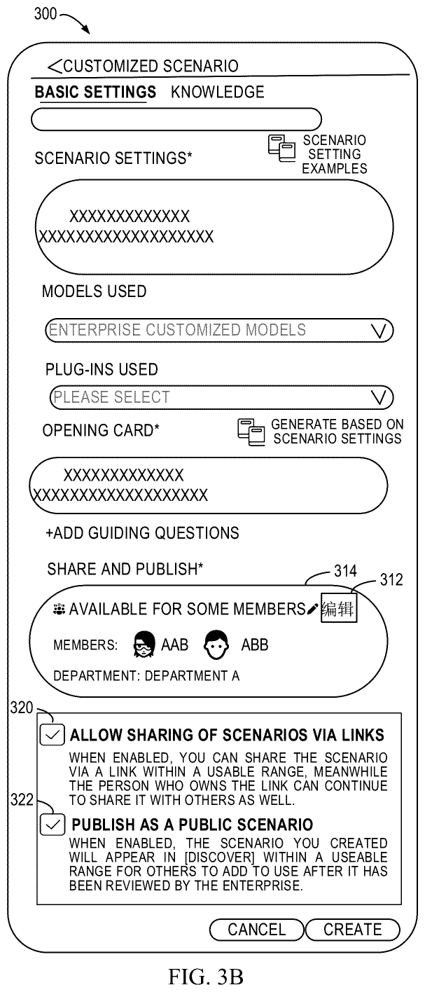

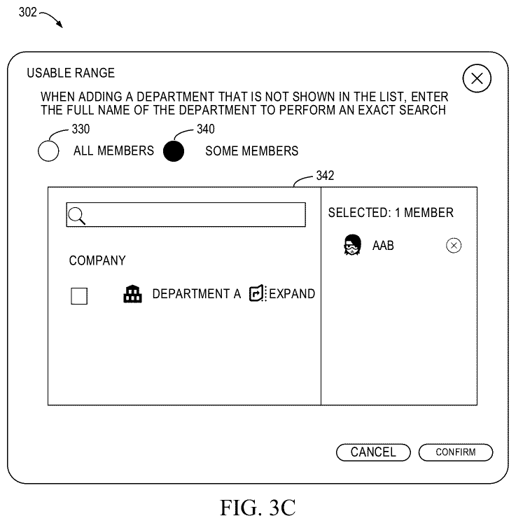

The foregoing describes the user presentation of the creation scenario on the scenario recommendation page, and the creation scenario is described in the following with reference to FIG. 3A to FIG. 3C.

FIGS. 3A-3C illustrate schematic diagrams of an example client interface 300 for creating a scenario, according to some embodiments of the disclosure. The client interface 300 may be implemented at the terminal device 110. Examples of FIGS. 3A-3C are described below with reference to FIG. 1.

In response to receiving the first user's triggering operation, the terminal device 110 may, for example, provide the interface 300 shown in FIG. 3A, FIG. 3B or FIG. 3C. The interface 300 includes a page 310 for presenting a scenario to which a user has added. In some embodiments, only the page 310 may be included in the interface 300 provided by the terminal device 110. The page 310 includes a plurality of scenarios of the user and an operation control 301 for creating the scenarios. In some embodiments, the page 310 may be referred to as a page for presenting a scenario list. The scenario list may include, for example, all the scenarios that the user can select for interacting with the digital assistant.

The terminal device 110 may determine that a scenario creating operation is received in response to detecting the first user's trigger operation on the operation control 301 in the interface 300 shown in FIG. 3A to FIG. 3C. Alternatively or additionally, in some embodiments, the terminal device 110 may also determine that a scenario creation operation was received in response to receiving a user input indicating creation of a scenario in the conversation window. In response to receiving the scenario creation operation, the terminal device 110 may present a page for creating the target scenario. Such a page may be, for example, as shown in the interface 300 shown in FIG. 3B. The terminal device 110 presents a configuration information page for receiving a custom scenario in the interface 300. In some embodiments, respective scenarios may be created by the first user or any other user. Hereinafter, the creation of a scenario by the first user through the terminal device 110 is described for descriptive purposes only.

The terminal device 110 may obtain the scenario creation information of the target scenario through the configuration information page. In some embodiments, the scenario creation information may include a basic setting of the target scenario. The basic setting include: public permission type information, usable range information, scenario setting information, etc. The scenario setting information is used for describing information related to at least one scenario. In some embodiments, the scenario setting information can further include a description of a task of a target type corresponding to at least one scenario, a reply style of the digital assistant in the at least one scenario, a definition of a workflow to be executed in the at least one scenario, a definition of a reply format of the digital assistant in the at least one scenario, and the like.

In some embodiments, a public permission type of a target scenario to be created may further be configured in the configuration information page. As shown in FIG. 3B, it may be determined that the public permission of the scenario is of the designated type, i.e., the first type, based on the user's ticking of the select box 320 located before “the terminal device 110 allows the corresponding scenario to be provided in the scenario recommendation page 240 (“published as a public scenario”). The terminal device 110 determines that the public permission of the scenario is of the second type based on the user's ticking the selection box 322 located before “the terminal device 110 allows the corresponding scenario to be shared through the link”.

In one example, a public permission type of each of the at least one scenario is configured by a corresponding creator. For example, an individual user, when customizing his/her own scenario, may specify whether to configure the public permission of the scenario as “public scenario” so as to be presented in a scenario recommendation page of the user within an applicable range.

In some embodiments, the public permission types for certain scenarios are defaulted as designated types. For example, in addition to the customized scenario by an individual user as described with respect to FIGS. 3A-3B, some system configured scenarios (also referred to as official configured scenarios) can be provided. These scenarios may be provided, for example, by a operation team of a digital assistant. For such scenarios, the public permission type may be defaulted as a designated type, i.e., “publish as a public scenario”. Such scenarios may always be presented in a scenario recommendation page within the usable range. In some embodiments, the usable range of the system configured scenarios may include individual users of the digital assistant.

In some embodiments, when the terminal device 110 determines that the public permission of the scenario is of the first type (i.e. a designated type) based on the first user's selection of publishing a certain scenario as a public scenario, the terminal device 110 indicates that the created scenario will appear in the user's scenario recommendation page within the usable range for other users to add and use. When the terminal device 110 determines, based on the first user's selection of sharing the scenario via the link, that the public permission of the scenario is of the second type, the terminal device 110 indicates that the first user can share the scenario via the link within the usable range, and meanwhile other users having the link can also continue to share the scenario with other users. When a user that is not within the use range clicks on the link, the terminal device 110 presents a prompt “you do not have the use permission of the scenario, please contact @scenario creator for application’.

As shown in FIG. 3B and FIG. 3C, the terminal device 110 presents, on the interface 300, an information box 314 based on a trigger operation on the scenario recommendation page 240 by the first user, where the information box 314 is used for indicating that the terminal device 110 determines whether respective usable ranges of at least one scenario include at least the first user. The terminal device 110 presents a editing page 302 of the usable range based on the user clicking the editing control 312 in the information box 314. In the editing page 302, the scenario creator can select a useable range for the created scenario, e.g., designating one or more users, a group of users (e.g., a part of a company, etc.) in the useable range. Upon receiving an editing confirmation on the usable range, the usable range for the created scenario may be determined.

For example, when the usable range selected according to the user's need includes all members, the user may tick a selection box 330 before “all members”, and the terminal device 110 determines the usable range of the scenario in response to a triggering operation by the user. When the usable range selected according to the user's need is a part of members in department B, the user may tick a selection box 340 before “a part of members”, and then select “department B” or select a member by searching, and the terminal device 110 determines the usable range of the scenario in response to a trigger operation by the user. With respect to departments not presented by the terminal device 110, the user may input the full name of the department in a search page 324 to conduct a precise search.

In some embodiments, the terminal device 110 receives configuration information about the at least one scenario (such as public permission type information and usable range information,) on a page of configuration information about the at least one scenario (a “custom scenario”) from the first user, and after the first user clicks a touch control operation, such as a creation control, the terminal device 110 prompts successful creation.

In some embodiments, the terminal device 110 may cancel creation of a scenario in response to receiving a trigger operation on a cancellation control, for example, a trigger operation on a cancellation control in a form of “-”, and in response to the cancellation of the creation of the at least one scenario, the terminal device 110 may suspend display the scenario and remove same from a scenario (“my scenario”) list associated with the first user, i.e. not display same in the “my scenario” list.

In some embodiments, when the first scenario for the first user to interact with the digital assistant is selected, the terminal device 110 will end the previous topic and create a new topic in the interaction window between the first user and the first digital assistant, the new topic being associated with the first scenario.

In some embodiments, the terminal device 110 provides a resource obtaining indication for the first scenario according to a trigger on the first scenario by the user. The terminal device 110 adds the first scenario to a scenario (“my scenario”) list associated with the first user according to the amount of pre-demand resources added by the user to the first resource. For example, the terminal device 110 sorts the scenarios from high to low according to the scenario addition amount, and presents the scenario with the largest scenario addition amount on the top.

According to some embodiments of the present disclosure, at least one scenario recommended to the user is presented in the scenario recommendation page according to triggering by the user. The user may add one or more scenarios to their own scenario list for subsequent selection or select a scenario for interaction with the digital assistant, via the scenario recommendation page. Therefore, in this way, the digital assistant can be enabled to fulfill and facilitate the user's requirements for information interaction through the scenario recommendation page in respective scenarios.

When a scenario is published, in response to an operation of publishing the first scenario, first publication information of the first scenario is obtained. Based on the first publishing information, the first scenario is published to the target digital assistant, so that the target digital assistant executes a relevant task based on the first scenario. According to this solution, when creating a scenario for a specific digital assistant, a user may publish the created scenario to the specific digital assistant for use. For example, in the example of FIG. 3A, if a certain user of the “XX Assistant” created and published a first scenario for the XX Assistant, the published first scenario may be provided to the “XX Assistant” to perform the relevant tasks.

In some embodiments, when the first scenario is created, the manner for publishing the first scenario may be specified by a creator of the scenario, including a manner of sharing via a link, publicly publishing, or both. Different publishing manners correspond to different public permission types of the first scenario. As shown in FIG. 3B, based on the user's ticking of a selection box 320 located before “the terminal device 110 allows a corresponding scenario to be provided in the scenario recommendation page 240 (“publishing as a public scenario”), it is determined that the public permission of the scenario is of a designated type, i.e. the first type, and the publishing manner corresponding thereto is a publicly publishing manner. The terminal device 110 determines, based on the user's ticking of the selection box 322 located before “the terminal device 110 allows the corresponding scenario to be shared through the link”, it is determined that the public permission of the scenario is the second type, and the corresponding publishing manner thereof is a link sharing manner. If the creator ticks the two types at the same time, the published first scenario may be published in a link sharing manner, or may be published publicly, that is, presented in a scenario recommendation page of a user within a usable range.

In some embodiments, the first publication information for the first scenario may also include a usable range to indicate a range of users to whom the first scenario is usable. In this way, users within the designated useable range are able to use the first scenario to interact with respective digital assistants.

In some embodiments, the target digital assistant to which the first scenario is published may include a digital assistant to which each of one or more users corresponds. For example, a first user has a first digital assistant of his/her own, and a second user has a second digital assistant of his/her own, as the digital assistants of different users are configured with respective user permissions, historical interaction information, and the like. However, digital assistants of different users may be understood to be instances of the same digital assistant application running on terminal devices of different users. When the first scenario is published, one or more users that can use the first scenario are included within a usable range of the first scenario.

According to embodiments of the present disclosure, interaction between digital assistants and users can be enriched by creating diversified scenarios for a particular digital assistant. As described above, configuration information of a scenario may include scenario setting information, plug-in information, and the like. By setting different configuration information for different scenarios, when performing interaction based on a corresponding scenario, the digital assistant can present different interaction capabilities, which helps a user complete different tasks.

It should be appreciated that some embodiments of the present disclosure have been described above in conjunction with specific examples in the drawings, but these specific examples are not intended to limit the scope of the embodiments of the present disclosure. The described embodiments may also be implemented in various other variants.

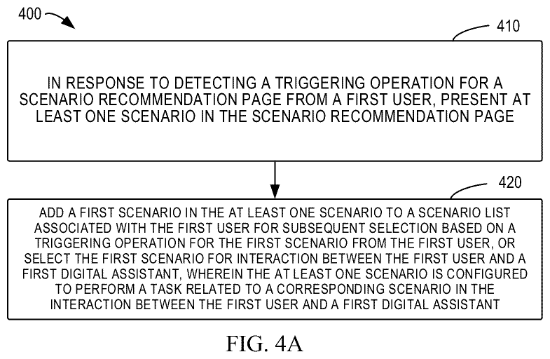

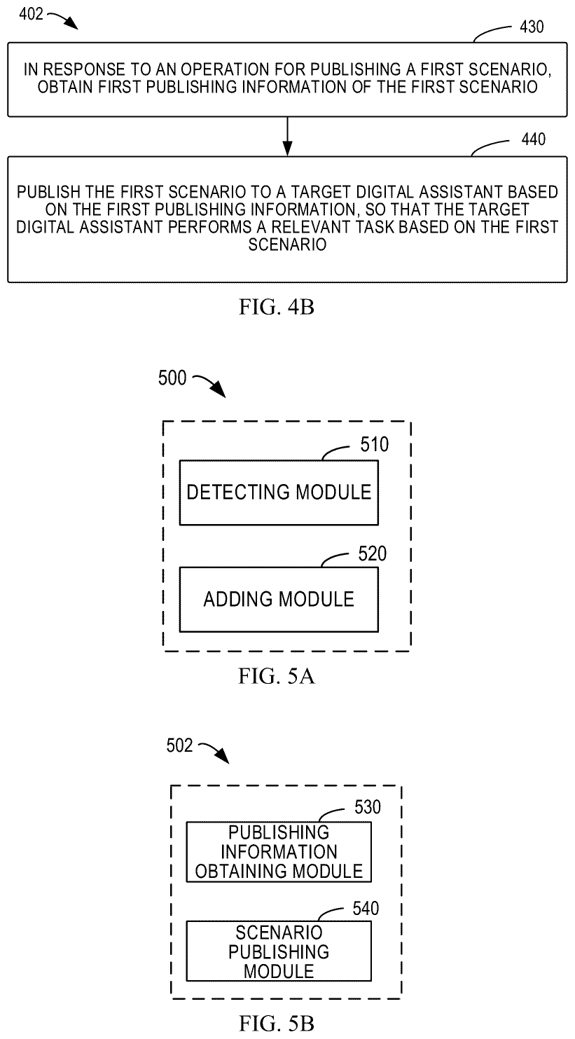

FIG. 4A illustrates a flowchart of a process 400 of information interaction, according to some embodiments of the disclosure. The process 400 may be implemented at a terminal device 110. Process 400 is described below with reference to FIG. 1.

At block 410, the terminal device 110 presents, in response to detecting a triggering operation for a scenario recommendation page from a first user, at least one scenario in the scenario recommendation page.

At block 420, the terminal device 110 adds a first scenario in the at least one scenario to a scenario list associated with the first user for subsequent selection based on a triggering operation for the first scenario by the first user, or selects the first scenario for interaction between the first user and a first digital assistant, wherein the at least one scenario is respectively configured to perform a task related to a corresponding scenario in the interaction between the first user and a first digital assistant.

In some embodiments, presenting the at least one scenario in the scenario recommendation page includes: determining whether a public permission type of each of the at least one scenario is a designated type, public permission of the designated type allowing a corresponding scenario to be provided in the scenario recommendation page; and presenting the at least one scenario in the scenario recommendation page based at least on determination on whether the public permission type of each of the at least one scenario is the designated type.

In some embodiments, presenting the at least one scenario in the scenario recommendation page includes: determining whether a usable range for each of the at least one scenario includes at least the first user; and presenting the at least one scenario in the scenario recommendation page based on a determination on whether the usable range for each of the at least one scenario includes at least the first user.

In some embodiments, the designated type of public permission indicates that a corresponding scenario is allowed to be provided in a scenario recommendation page of a user within a usable range.

In some embodiments, the at least one scenario is respectively configured with configuration information, and the configuration information at least indicates at least one of a public permission type and a usable range of each of corresponding scenarios.

In some embodiments, presenting the at least one scenario in the scenario recommendation page includes: presenting, in the scenario recommendation page, at least one of: a scenario description for each of the at least one scenario, an access portal for each of the at least one scenario, an add control for each of the at least one scenario, a creation source for each of the at least one scenario, an addition amount for each of the at least one scenario.

In some embodiments, adding the first scenario to the scenario list associated with the first user includes in response to detecting a triggering operation for an add control for the first scenario, adding the first scenario to the scenario list associated with the first user.

In some embodiments, selecting the first scenario for interaction between the first user and the first digital assistant includes selecting the first scenario for interaction between the first user and the first digital assistant in response to detecting a trigger operation to access a portal of the first scenario.

In some embodiments, the process 400 further includes, in response to the first scenario being selected for the interaction between the first user and the first digital assistant, creating a new topic based on the first scenario in an interaction window between the first user and the first digital assistant.

In some embodiments, adding the first scenario to the scenario list associated with the first user includes: providing a resource obtaining indication for the first scenario based on a triggering operation for the first scenario; and adding the first scenario to the scenario list associated with the first user in response to receiving a predetermined resource amount required for addition of the first resource.

In some embodiments, a public permission type of each of one or more scenarios in the at least one scenario is configured by a corresponding creator, and/or wherein the public permission type of each of one or more scenarios in the at least one scenario is defaulted as the designated type.

In some embodiments, the at least one scenario is respectively configured with configuration information, and the configuration information at least indicates at least one of: scenario setting information, the scenario setting information being configured for describing information related to a corresponding scenario; plug-in information, the plug-in information indicating at least one plug-in for performing a task in a corresponding scenario; an indication for a selected model, the model being called to determine a reply to the user in a corresponding scenario; scenario guiding information, the scenario guiding information being presented to a user after a corresponding scenario is selected; and at least one recommendation question for the digital assistant, the at least one recommended question being presented to the user for selection after a corresponding scenario is selected.

FIG. 4B illustrates a flow chart of an information interaction process 402 according to some embodiments of the present disclosure. The process 402 is described below with reference to FIG. 1.

At block 430, the terminal device 110 obtains first publishing information of the first scenario in response to an operation for publishing a first scenario. The first scenario is configured with corresponding configuration information to execute a task of a corresponding type. The configuration information comprises at least one of: scenario setting information and plug-in information, wherein the scenario setting information is configured for describing information related to a corresponding scenario, and the plug-in information indicates at least one plug-in for performing a task in a corresponding scenario.

At block 440, the terminal apparatus 110 publishes the first scenario to a target digital assistant based on the first publishing information, so that the target digital assistant performs a relevant task based on the first scenario.

In some embodiments, the first publishing information comprises a publishing manner, the publishing manner including at least one of: a link sharing manner; a publicly publishing manner.

In some embodiments, the first publishing information includes a usable range, which indicates a range of users to whom the first scenario is usable.

In some embodiments, the target digital assistant includes a digital assistant corresponding to each of one or more users. In some embodiments, the one or more users are determined by a usable range of the first scenario.

FIG. 5A illustrates a block diagram of an apparatus for information interaction 500 according to some embodiments of the disclosure. The apparatus 500 may be implemented in or included in a terminal apparatus 110, for example. The various modules/components of the apparatus 500 may be implemented by hardware, software, firmware, or any combination thereof.

As shown in the drawings, the apparatus 500 includes detecting module 510 configured to present, in response to detecting a triggering operation for a scenario recommendation page from a first user, at least one scenario in the scenario recommendation page.

The apparatus 500 further includes an adding module 520 configured to add a first scenario in the at least one scenario to a scenario list associated with the first user for subsequent selection based on a triggering operation for the first scenario by the first user, or select the first scenario for interaction between the first user and a first digital assistant. At least one scenario is respectively configured to perform a task related to a corresponding scenario in the interaction between the first user and a first digital assistant.

In some embodiments, presenting the at least one scenario in the scenario recommendation page includes: determining whether a public permission type of each of the at least one scenario is a designated type, public permission of the designated type allowing a corresponding scenario to be provided in the scenario recommendation page; and presenting the at least one scenario in the scenario recommendation page based at least on determination on whether the public permission type of each of the at least one scenario is the designated type.

In some embodiments, presenting the at least one scenario in the scenario recommendation page includes: determining whether a usable range for each of the at least one scenario includes at least the first use; and presenting the at least one scenario in the scenario recommendation page based on a determination on whether the usable range for each of the at least one scenario includes at least the first user.

In some embodiments, the designated type of public permission indicates that a corresponding scenario is allowed to be provided in a scenario recommendation page of a user within a usable range.

In some embodiments, the at least one scenario is respectively configured with configuration information, and the configuration information at least indicates at least one of a public permission type and a usable range of each of corresponding scenarios.

In some embodiments, presenting the at least one scenario in the scenario recommendation page includes: presenting, in the scenario recommendation page, at least one of: a scenario description for each of the at least one scenario, an access portal for each of the at least one scenario, an add control for each of the at least one scenario, a creation source for each of the at least one scenario, an addition amount for each of the at least one scenario.

In some embodiments, adding the first scenario to the scenario list associated with the first user includes: in response to detecting a triggering operation for an add control for the first scenario, adding the first scenario to the scenario list associated with the first user.

In some embodiments, selecting the first scenario for the interaction between the first user and the first digital assistant includes: in response to detecting a triggering operation for an access portal for the first scenario, selecting the first scenario for the interaction between the first user and the first digital assistant.

In some embodiments, the adding module 520 is further configured to: create, in response to the first scenario being selected for the interaction between the first user and the first digital assistant, a new topic based on the first scenario in an interaction window between the first user and the first digital assistant.

In some embodiments, adding the first scenario to the scenario list associated with the first user includes: providing a resource obtaining indication for the first scenario based on a triggering operation for the first scenario; and adding the first scenario to a scenario list associated with the first user in response to receiving a predetermined resource amount required for the addition of the first resource.

In some embodiments, a public permission type of each of one or more scenarios in the at least one scenario is configured by a corresponding creator, and/or wherein the public permission type of each of one or more scenarios in the at least one scenario is defaulted as the designated type.

In some embodiments, the at least one scenario is respectively configured with configuration information, and the configuration information at least indicates at least one of: scenario setting information, the scenario setting information being configured for describing information related to a corresponding scenario; plug-in information, the plug-in information indicating at least one plug-in for performing a task in a corresponding scenario; an indication for a selected model, the model being called to determine a reply to the user in a corresponding scenario; scenario guiding information, the scenario guiding information being presented to a user after a corresponding scenario is selected; at least one recommendation question for the digital assistant, the at least one recommended question being presented to the user for selection after a corresponding scenario is selected.

FIG. 5B illustrates a block diagram of an apparatus for information interaction 502 according to some embodiments of the disclosure. The apparatus 500 may be implemented in or included in a terminal apparatus 110, for example. The various modules/components of the apparatus 502 may be implemented by hardware, software, firmware, or any combination thereof.

In some embodiments, the apparatus 502 comprises a publishing information obtaining module 502 configured to obtain, in response to an operation for publishing a first scenario, first publishing information of the first scenario, wherein the first scenario is configured with corresponding configuration information to execute a task of a corresponding type, the configuration information comprises at least one of: scenario setting information and plug-in information, wherein the scenario setting information is configured for describing information related to a corresponding scenario, and the plug-in information indicates at least one plug-in for performing a task in a corresponding scenario. In some embodiments, the apparatus 502 further comprises a scenario publishing module 540 configured to publish, based on the first publishing information, the first scenario to a target digital assistant, so that the target digital assistant performs a relevant task based on the first scenario.

In some embodiments, the first publishing information includes a publishing manner, the publishing manner including at least one of: a manner of sharing via a link; a publicly publishing manner.

In some embodiments, the first publishing information includes a usable range, and the usable range indicates a range of users to whom the first scenario is usable.

In some embodiments, the target digital assistant comprises a digital assistant corresponding to each of one or more users. In some embodiments, the one or more users are determined by a usable range of the first scenario.

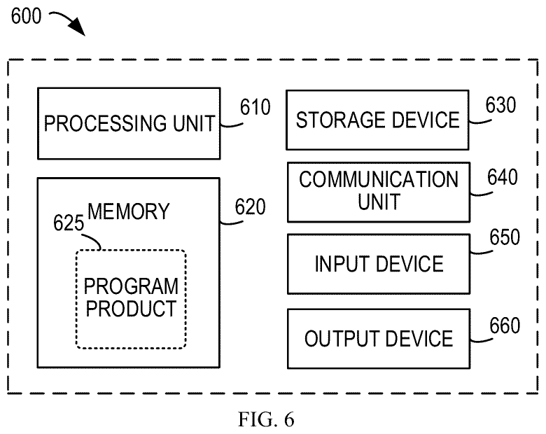

FIG. 6 illustrates a block diagram of an electronic device 600 in which one or more embodiments of the present disclosure may be implemented. It should be appreciated that the electronic device 600 shown in FIG. 6 is merely exemplary and should not constitute any limitation on the functionality and scope of the embodiments described herein. The electronic device 600 shown in FIG. 6 may be used to implement the terminal device 110 of FIG. 1, the apparatus 500 shown in FIG. 5A and/or the apparatus 502 shown in FIG. 5B.

As shown in FIG. 6, the electronic device 600 is in the form of a general-purpose electronic device. Components of the electronic device 600 may include, but are not limited to, one or more processors or processing units 610, a memory 620, a storage device 630, one or more communications units 640, one or more input devices 650, and one or more output devices 660. The processing unit 610 may be an actual or virtual processor and can perform various processes according to programs stored in the memory 620. In a multiprocessor system, a plurality of processing units execute computer executable instructions in parallel, so as to improve the parallel processing capability of the electronic device 600.

The electronic device 600 typically includes several computer storage media. Such media may be any available media that are accessible by electronic device 600, including, but not limited to, volatile and non-volatile media, removable and non-removable media. The memory 620 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium such as a flash drive, a magnetic disk, or any other medium that can be used to store information and/or data and that can be accessed within the electronic device 600.

The electronic device 600 may further include additional removable/non-removable, volatile/nonvolatile storage media. Although not shown in FIG. 6, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 implements communication with other electronic devices through a communication medium. In addition, functions of components of the electronic device 600 may be implemented by a single computing cluster or a plurality of computing machines, and these computing machines can communicate through a communication connection. Thus, the electronic device 600 may operate in a networked environment using logical connections to one or more other servers, network personal computers (PCs), or another network node.

The input device 650 may be one or more input devices such as a mouse, keyboard, trackball, etc. The output device 660 may be one or more output devices such as a display, speaker, printer, etc. The electronic device 600 may also communicate with one or more external devices (not shown) such as a storage device, a display device, or the like through the communication unit 640 as required, and communicate with one or more devices that enable a user to interact with the electronic device 600, or communicate with any device (e.g., a network card, a modem, or the like) that enables the electronic device 900 to communicate with one or more other electronic devices. Such communication may be performed via an input/output (I/O) interface (not shown).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices, and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method of information interaction, comprising:
in response to detecting a triggering operation for a scenario recommendation page from a first user, presenting at least one scenario in the scenario recommendation page; and
adding a first scenario of the at least one scenario to a scenario list associated with the first user for subsequent selection based on a triggering operation for the first scenario from the first user, or selecting the first scenario for interaction between the first user and a first digital assistant,
wherein the at least one scenario is configured to perform a task related to a corresponding scenario in the interaction between the first user and the first digital assistant.

2. The method of claim 1, wherein presenting the at least one scenario in the scenario recommendation page comprises:
determining whether a type of public permission of each of the at least one scenario is a designated type, the public permission of the designated type allowing a corresponding scenario to be provided in the scenario recommendation page; and
presenting the at least one scenario in the scenario recommendation page based at least on determination on whether the type of the public permission of each of the at least one scenario is the designated type.

3. The method of claim 1, wherein presenting the at least one scenario in the scenario recommendation page comprises:
determining whether a usable range for each of the at least one scenario comprises at least the first user; and
presenting the at least one scenario in the scenario recommendation page based on a determination on whether the usable range for each of the at least one scenario comprises at least the first user.

4. The method of claim 2, wherein the public permission of the designated type indicates that a corresponding scenario is allowed to be provided in a scenario recommendation page for a user within a usable range.

5. The method of claim 2, wherein the at least one scenario is configured with configuration information, and the configuration information at least indicates at least one of a type of public permission or a usable range of each of corresponding scenarios.

6. The method of claim 1, wherein presenting the at least one scenario in the scenario recommendation page comprises:
presenting, in the scenario recommendation page, at least one of:
a scenario description for each of the at least one scenario,
an access portal for each of the at least one scenario,
an add control for each of the at least one scenario,
a creation source for each of the at least one scenario, or
an addition amount for each of the at least one scenario.

7. The method of claim 6, wherein adding the first scenario to the scenario list associated with the first user comprises:
in response to detecting a triggering operation on an add control for the first scenario, adding the first scenario to the scenario list associated with the first user.

8. The method of claim 6, wherein selecting the first scenario for the interaction between the first user and the first digital assistant comprises:
in response to detecting a triggering operation on an access portal for the first scenario, selecting the first scenario for the interaction between the first user and the first digital assistant.

9. The method of claim 1, further comprising:
in response to the first scenario being selected for the interaction between the first user and the first digital assistant, creating a new topic based on the first scenario in an interaction window between the first user and the first digital assistant.

10. The method of claim 1, wherein adding the first scenario to the scenario list associated with the first user comprises:
providing a resource obtaining indication for the first scenario based on the triggering operation for the first scenario; and
adding the first scenario to a scenario list associated with the first user in response to receiving a predetermined resource amount required for addition of a first resource.

11. The method of claim 1, wherein respective types of public permission of one or more scenarios in the at least one scenario are configured by a corresponding creator, and/or
wherein respective types of public permission of one or more scenarios in the at least one scenario are determined as a designated type by default.

12. The method of claim 1, wherein the at least one scenario is configured with configuration information, and the configuration information at least indicates at least one of:
scenario setting information configured for describing information related to a corresponding scenario;
plug-in information indicating at least one plug-in for performing a task in the corresponding scenario;
an indication of a selected model, the model being invoked to determine a reply to the user in a corresponding scenario;
scenario guiding information, the scenario guiding information being presented to a user after the corresponding scenario is selected; and
at least one recommendation question for the digital assistant, the at least one recommended question being presented to the user for selection after the corresponding scenario is selected.

13. A method of information interaction, comprising:
in response to an operation for publishing a first scenario, obtaining first publishing information of the first scenario, wherein the first scenario is configured with corresponding configuration information to execute a task of a corresponding type, the configuration information comprises at least one of scenario setting information or plug-in information, wherein the scenario setting information is configured for describing information related to a corresponding scenario, and the plug-in information indicates at least one plug-in for performing a task in a corresponding scenario; and
publishing the first scenario to a target digital assistant based on the first publishing information, so that the target digital assistant performs a relevant task based on the first scenario.

14. The method according to claim 13, wherein the first publishing information comprises a publishing manner, the publishing manner comprising at least one of:
a manner of sharing via a link; or
a publicly publishing manner.

15. The method of claim 13, wherein the first publishing information comprises a usable range, the usable range indicates a range of users to whom the first scenario is usable.

16. The method of claim 13, wherein,
the target digital assistant comprises a digital assistant corresponding to each of one or more users, and
the one or more users are determined by a usable range of the first scenario.

17. An electronic device, comprising:
at least one processing unit; and
at least one memory, the at least one memory being coupled to the at least one processing unit and storing instructions for execution by the at least one processing unit, instructions, when executed by the at least one processing unit, cause the electronic device to perform acts comprising:
in response to detecting a triggering operation for a scenario recommendation page from a first user, presenting at least one scenario in the scenario recommendation page; and
adding a first scenario of the at least one scenario to a scenario list associated with the first user for subsequent selection based on a triggering operation for the first scenario from the first user, or selecting the first scenario for interaction between the first user and a first digital assistant,
wherein the at least one scenario is configured to perform a task related to a corresponding scenario in the interaction between the first user and the first digital assistant.

18. The device of claim 17, wherein presenting the at least one scenario in the scenario recommendation page comprises:
determining whether a type of public permission of each of the at least one scenario is a designated type, the public permission of the designated type allowing a corresponding scenario to be provided in the scenario recommendation page; and
presenting the at least one scenario in the scenario recommendation page based at least on determination on whether the type of the public permission of each of the at least one scenario is the designated type.

19. The device of claim 17, wherein presenting the at least one scenario in the scenario recommendation page comprises:
determining whether a usable range for each of the at least one scenario comprises at least the first user; and
presenting the at least one scenario in the scenario recommendation page based on a determination on whether the usable range for each of the at least one scenario comprises at least the first user.

20. The device of claim 17, wherein presenting the at least one scenario in the scenario recommendation page comprises:
presenting, in the scenario recommendation page, at least one of:
a scenario description for each of the at least one scenario,
an access portal for each of the at least one scenario,
an add control for each of the at least one scenario,
a creation source for each of the at least one scenario, or
an addition amount for each of the at least one scenario.
